(19) United States
(12) Patent Application Publication
(10) Pub. No.: US 2006/0156297 A1
(43) Pub. Date: Jul. 13, 2006

(54) Method and device for modifying software in a control unit and corresponding control unit

(76) Inventor: Peter Joest, Bensheim (DE)

Correspondence Address: KENYON & KENYON LLP, ONE BROADWAY, NEW YORK, NY, 10004, US

(21) Appl. No.: 10/539,494

(22) PCT Filed: Dec. 17, 2003
(86) PCT No.: PCT/DE03/04159

§ 371 Date: Dec. 28, 2005

(30) Foreign Application Priority Data
Dec. 19, 2002 (DE) 102 60 103.8

(51) Int. Cl. G06F 9/44

(52) U.S. Cl. 717/168

(57) ABSTRACT

A method and device for changing software in a first memory area in a control unit for controlling operational sequences, the execution of old software parts being replaced by the execution of new software parts and the old software parts being written into the first memory area, the new software parts being written into a second memory area and, due to a first branching in the first memory area, instead of the old software parts being executed in the first memory area, the new software parts are executed in the second memory area, the system, following the execution of the new software parts, branching back again into the first memory area via a second branching in the second memory area and the execution of the other software distinct from the old software parts being continued in the first memory area, the old software parts remaining in the first memory area.

### FIELD OF THE INVENTION

The present invention relates to a method and a device for changing software in a first memory area in a control unit as well as a corresponding control unit and a computer program for implementing the method.

### BACKGROUND INFORMATION

In the automotive industry in particular, evermore complex functions are implemented in the individual control units with the aid of software. More and more frequently it is necessary to incorporate changes of the software in the control unit just prior to or also following the delivery to end customers. The changes of the software of a control unit are generally handled in such a way that the changes are incorporated into a new software integration version and that this newly prepared software is loaded completely into the control unit, in particular by storing it in a so-called flash EPROM memory, i.e. by flashing. Due to the existing size of the software, flashing a control unit, for example, now already takes up to 30 minutes. Due to the sharp increase in functions and functionality, and hence due to an even greater software size and a greater number of software packages, this time will increase even more dramatically in the future.

### SUMMARY OF THE INVENTION

Therefore, it is an objective of the present invention to reduce this time requirement for flashing a control unit, which will result in additional advantages as well.

The present invention relates to a method and a device for changing software in a first memory area in a control unit for controlling operational sequences, particularly in a vehicle, as well as in a corresponding control unit, the execution of old software being replaced by the execution of new software parts and the old software parts being written into the first memory area. In most cases the software changes, in particular changes of the program code, are small in comparison to the portion of the software that requires no change. Advantageously, the portions to be changed or generally only parts of a software are now loaded in a targeted manner into the control unit, these software parts being also referred to as patch containers in the specification or being contained in such a patch container.

That is, suitably, only the new software parts are written into a second memory area, where, due to a first branching in the first memory area, instead of the old software parts being executed in the first memory area, the new software parts in the second memory area are executed and, following the execution of the new software parts, due to a second branching in the second memory area, the system branches back again into the first memory area, the execution of the additional software that is distinct from the old software parts being continued in the first memory area and the old software parts remaining in the first memory area.

That is to say, to implement the changes of the existing software, that is, the old software parts, a patch manager, in particular a central patch manager, is installed, with the aid of which the parts of the software to be changed may be changed in a targeted manner by entry and exit. On the one hand, this advantageously allows for a marked reduction of the extensive time needed for flashing large software sections or software parts, since on the one hand, as already hinted at above, it is not the entire software that is newly written in and on the other hand also the time required for changing the software, that is, particularly to erase it and to write it in anew, is economized.

This additionally results in a higher flexibility in changing software and software parts and on the other hand in a reduced susceptibility to error by the fact that software parts are overwritten or erased and newly written-in as little as possible.

This is suitably implemented particularly in that the second memory area, that is, the patch container area, is only used for receiving the new software parts and for integrating them into the program run or the software execution.

For this purpose, suitably, the first branching and the second branching may be implemented by at least one chained list. Chained lists in this context provide a space-saving opportunity to store data, particularly of software parts, which have at the same time a temporal as well as a logical order. Since, in this manner, there may be several versions of comparable or identical software parts, chained lists are a good approach for storing versions of different software parts, the number of which cannot be determined in advance. In the case of chained lists, for every version of a software part or for every software part there is a pointer or a reference to the next version of this software part. A special pointer state may be used for coding in case the associated version is the most current version of the respective software part. Likewise, this special pointer state may be used as identification or an identifier for the respective software part. In this context, relative or absolute addresses are used as a reference. Thus, in the case of a chained list, together with a respectively stored software part or together with an information unit such as a data record containing the software part, a reference to the storage location of the respectively next logically connected information unit is stored, particularly here either the next new software part or data record having the new software part or also the additional software following the old software part. Thus, the storage locations can also only be occupied at the time, at which the information to be stored or to be newly executed is available. Thus it is also possible to assign to this information the respectively next free storage location, whereby this procedure also results in a continuous usage of the memory.

Expediently, a start address of the new software parts is now used as the first branching, quasi for the exit from the first memory area, with which start address the old software parts, that is, the software parts, that is, the software parts to be changed, can be at least partially overwritten. Alternatively, memory space may also be provided for integrating the exit address in the first memory area. Thus, in the first memory area an exit is set into or towards the patch container. As a second branching, quasi as a return, a start address of the additional software that is distinct from the old software parts is then used in an advantageous manner such that, immediately following the jumping around of the old software parts, the additional, subsequent software in the first memory area is used or executed.

The new software parts advantageously contain information indicating which old software parts are to be replaced and/or information indicating with which new software parts the old software parts are to be replaced. Expediently, for this purpose, the second memory area, that is, in particular every input patch container in a patch table, which contains the new software parts as well as possibly additional information, contains in addition to at least one new software part an address for the first branching, an address for the second branching and an address for the start of the old software part that is to be replaced by the at least one new software part. As additional information, advantageously the length of the at least one new software part and/or also of the at least one old software part may be contained in the patch container as well. These elements, that is, an address for the first branching, an address for the second branching, an address for the start of the old software part as well as possibly the length of the new software part and/or of the old software part may be integrated into a data record in the patch container, that is, in the second memory area, particularly in the patch table. Thus, the information required for replacing an old software part is expediently integrated into such a data record for every old software part.

For this purpose, advantageously, the first memory area may be implemented as a first table and the second memory area as a second table (patch table) in the same memory.

For this purpose, it is also possible to divide the first memory area and the second memory area expediently into two software sections of equal size, it being possible for a new software part to be written into each software section of the second memory area.

Expediently, also each data record or each software section according to the specific embodiment may then receive an identification, which allows for an allocation of an old software part and of a new software part replacing it.

### BRIEF DESCRIPTION OF THE DRAWINGS

FIG. 1 shows a control unit having suitable software, in which old software parts are replaced by new software parts.

FIG. 2 shows the first memory area having the control unit software as well as the patch container according to the present invention.

FIG. 3 shows an exemplary data record in the patch container.

### DETAILED DESCRIPTION

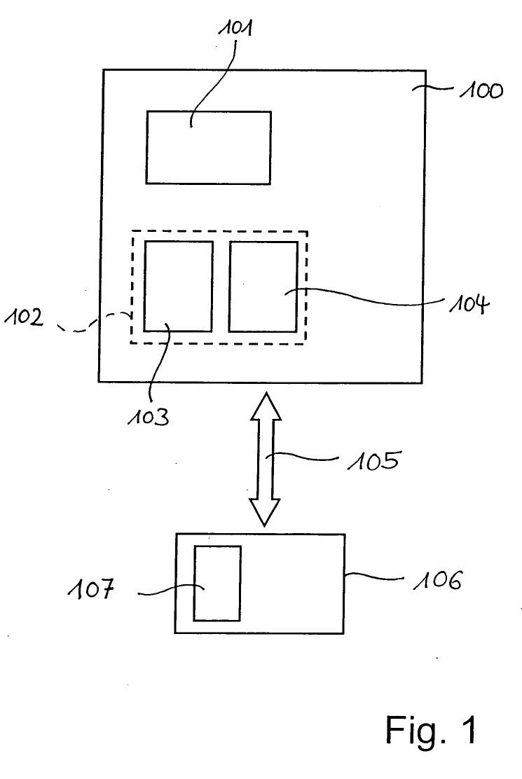

FIG. 1 shows a control unit 100 having a processing unit 101, particularly a microcontroller as well as memory arrangement 102, particularly divided into two memory areas 103 and 104. These memory areas 103 and 104 may exist in the same memory or in different memories of control unit 100. Via an interface 105, which may represent in addition to a wired also a wireless connection, the appropriate new software parts are introduced from a source 106, for example, another computer, by second memory arrangement 107 into control unit 100. Due to the fact that only the data to be changed are transmitted, that is, only the new software parts and not the entire software, which results in significantly lower transmission rates, it is possible to use in particular also air interfaces, that is, radio, ultrasound, infrared etc. In addition, however, wired transmission is also possible at this location.

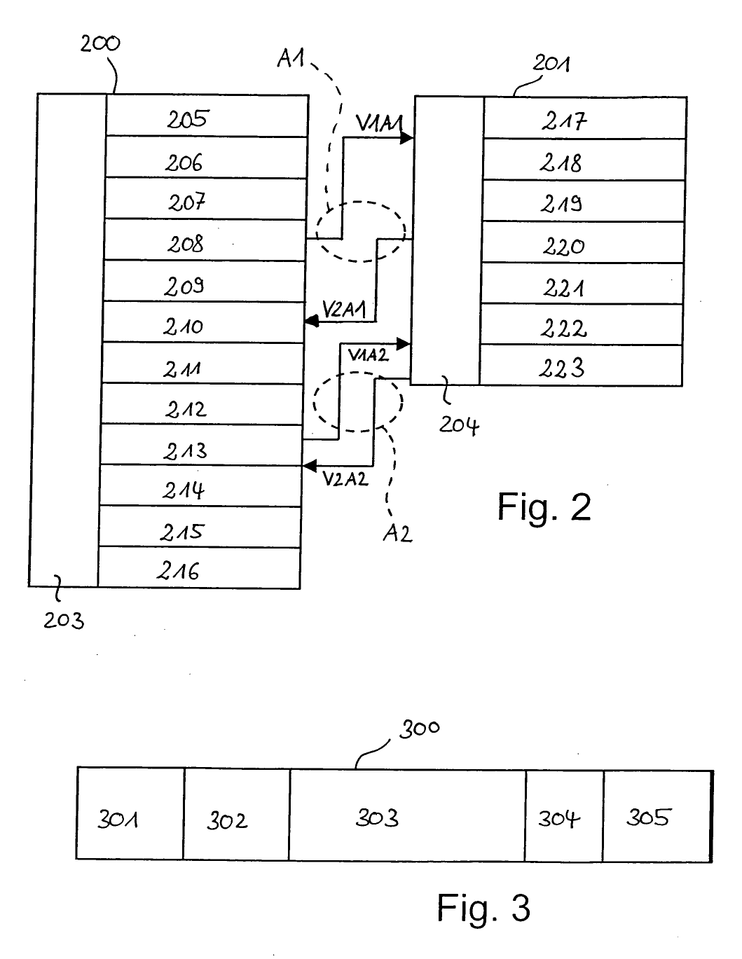

FIG. 2 now shows a first memory area 200 and a second memory area 201, in particular in the form of a table. The first memory area contains cells or software sections 205 through 216. The respective addresses of cells 205 through 216 are in each instance stored in block 203. Likewise, a second memory area 201, that is, the patch table, contains several cells 217 through 223, likewise software sections, in which the so-called patch containers may be stored. Here too, corresponding addresses are stored in block 204 with regard to the respective cell, that is, to the respective patch container.

As may be seen in FIG. 2, in the old software parts from first memory area 200, following software section 207, an exit is generated in software section 208 to patch table 201. For this purpose, the old software part 208 is overwritten at least partially with the exit address, that is, the branching to software section 218. That is to say, the first change A1 starts with a branching V1A1 from first memory area 200 into second memory area 201. Following the execution of software sections 218, 219, from software section 220 the system branches back or returns again by a second branching V2A1 into the first memory area, software section 210. Thus, in this manner, the old software parts in software sections 208 and 209 may be replaced by the new software parts in sections 218 and 219, that is, jumped around. In the process, the old software parts in sections 208 and 209 are preserved in the first memory area.

A second change A2, for example, shows an exit to section 212 at the start of section 223 in second memory area 201 and a return to the start of memory section 214. That is to say, due to first branching V1A2 and the return or second branching V2A2, software section 213 is replaced by software section 223 with respect to the software execution, the old software part in software section 213 again being at least partially preserved. Only that part is replaced that contains the jump address for the patch table.

To generate this state, as just described with reference to FIG. 2, information is required as to which software parts, that is, old software parts from memory area 200, are to be changed in what way. This information is loaded into patch table 201.

Using a patch manager, the address references between memory area 200 and memory area 201 are established in a restart of the control unit. The patch manager may be accommodated e.g. in the boot loader, that is, in the start program, which is executed during the start-up of the control unit. Depending on the resources, the patch table may contain a plurality of information within the scope of the patch manager, according to the exemplary embodiment and/or exemplary method of the present invention. This information, these elements may be integrated in individual data records, as shown in FIG. 3. The manager may also be implemented by processing unit 101 of the control unit itself in that the respective information is stored in the patch container.

To generate the data records for the patch table, an auxiliary device lends itself, particularly in computer 106, which analyzes the changes of the source code and generates the data records or the software parts for the patch table accordingly. These data records, for example, are made up of an exit address, the original software, that is, the old software parts, a destination address for the patch table, that is, a reference to a patch container, the new software part, that is, for example, changed or new hexadecimal code, for example also the length of the changed program code, that is, the length of the old software part or also the length of the new program code, that is, the new software part as well as the return address into the first storage area, that is, to the additional software distinct from the old software part, that is, in particular into the original program. Furthermore, an identifier or an identification may be assigned to a patch container and thus be contained in the data record.

At the same time, not all of the mentioned information is necessary for implementing the method according to the present invention. Thus the end address, for example, may be determined from the start address and the length of the software part. Nevertheless, the use of the information may either mean a time advantage, since it is not necessary to calculate an address, or redundant information in this connection may allow for a verification of the software change and thus for increased reliability.

In the same way, with a patch manager constructed in this manner it is also possible to reverse a change in the software. In such a reversal, memory space could then be provided in the first memory area for exit addresses, so that in a reuse of the old software part, the latter is not partially overwritten.

As an example of such a patch container or data record, block 300 is represented in FIG. 3. In this instance, 301 indicates a program address, that is, the address of the old software part to be replaced, while block 302 indicates the address in the patch table. Block 303 indicates the new in particular program code, that is, the new software part, which is to replace the old software part. Block 304, for example, indicates the length of the new software part, that is the code length in bits, bytes or any other quantity, and block 305 finally shows the return address to the other software parts, that is, in particular to the original program in first memory area 200.

In addition, as already mentioned, an identification, that is, an identifier may also be included, for example instead of the code length specification or also in addition to it. Such a patch container as block 300 or the entire patch table may be loaded very easily via a bus system into the control unit, e.g. via a CAN bus system with the CAN messages. If an identification or an identifier is used as discussed, that is, if it is assigned to a patch container, then it is possible in a very targeted manner to change the changes, e.g. error messages from customers, to track the changes and also to establish and also store a history of the changes without losing the transparency of the stable tested program code, that is, the error-free software. If a correction does not display the desired reaction, then it is easy to restore the old state, that is, simply to remove the patch container. Due to the low data rate, which serves the method according to the present invention, a simple correction or extension of the software is also possible via the air interface, as already mentioned.

Furthermore, it is advantageous to segment the memory area for the data, that is, the software, into data files of equal size, that is, software sections of equal size, which then likewise, as in the method as described above, are chained together and are stored for the changes in the patch table. That is to say, the cells or data packets or the software stored within them in first memory area 200 and in second memory area 201 do not necessarily have to be of equal size, rather this is managed via the addresses and the patch management. It may be advantageous, however, to use software sections of equal size for the first and the second memory area and always to exchange such complete software sections as a data record or to replace the old software parts by the new.

The above described exemplary embodiments and/or methods of the present invention in all of its developments thus yields an incremental flashing of a control unit having all of the mentioned advantages.

1-18. (canceled)

19. A method for changing software in a first memory area in a control unit for controlling operational sequences, the method comprising:
replacing execution of old software parts with execution of new software parts; and
writing the old software parts into the first memory area;
wherein the new software parts are written into a second memory area and, due to a first branching in the first memory area, instead of the old software parts being executed in the first memory area, the new software parts are executed in the second memory area, the control unit, following the execution of the new software parts, branching back again into the first memory area via a second branching in the second memory area and the execution of the other software distinct from the old software parts being continued in the first memory area, the old software parts remaining in the first memory area.

20. The method of claim 19, wherein the second memory area is only used to receive the new software parts.

21. The method of claim 19, wherein the first branching and the second branching are implemented by at least one chained list.

22. The method of claim 19, wherein as a first branching a start address of the new software parts is used, this being used to overwrite at least partially the old software parts.

23. The method of claim 19, wherein as the second branching a start address of the additional software distinct form the old software parts is used.

24. The method of claim 19, wherein the new software parts contain information that indicate which old software parts are to be replaced.

25. The method of claim 19, wherein the new software parts contain information that indicate by which new software parts the old software parts are to be replaced.

26. The method of claim 19, wherein the second memory area, in addition to at least one new software part, contains an address for the first branching, an address for the second branching and an address for the start of the old software part, which is to be replaced by the at least one new software part.

27. The method of claim 26, wherein the second memory area furthermore contains the length of at least one of the at least one new software part and of the at least one old software part.

28. The method of claim 27, wherein the addresses are integrated into a data record in the second memory area.

29. The method of claim 28, wherein at least two old software parts and the at least two new software parts, which replace these, are provided, the addresses being respectively integrated into one data record and written into the second memory area.

30. The method of claim 19, wherein as the first memory area a first table and as the second memory area a second table are provided in the same memory.

31. The method of claim 19, wherein the first memory area and the second memory area are divided into two software sections of equal size, a new software part being written into each software section of the second memory area.

32. The method of claim 28, wherein every data record or every software section is provided with an identification.

33. The method of claim 32, wherein the identification for a software section in the first memory area, which contains an old software part, and the identification for the corresponding software section having the new software part, which replaces the old software part, are the same.

34. A device for changing software in a first memory area in a control unit for controlling operational sequences, the device comprising:
a control unit for replacing the execution of old software parts with the execution of new software parts, and the old software parts being written into the first memory area, wherein an arrangement is included, which writes the new software parts into a second memory area and a first branching into the first memory area, whereby, instead of the old software parts being executed in the first memory area, the new software parts are executed in the second memory area, the arrangement also writing a second branching into the second memory area, whereby, following the execution of the new software parts, the control unit branches back again into the first memory area and the execution of the additional software distinct from the old software parts is continued in the first memory area, the old software parts remaining in the first memory area.

35. A control unit comprising:
a first memory area, in which old software parts and additional software parts distinct from the old software parts are stored;
a second memory area, which contains new software parts replacing the old software parts; and
an arrangement to write the new software parts into a second memory area and a first branching into the first memory area, whereby, instead of the old software parts being executed in the first memory area, the new software parts are executed in the second memory area, the arrangement also writing a second branching into the second memory area, whereby, following the execution of the new software parts, the control unit branches back again into the first memory area and the execution of the additional software distinct from the old software parts is continued in the first memory area, the old software parts remaining in the first memory area.

36. A computer program executable in a control unit, comprising:
program code for changing software in a first memory area in a control unit for controlling operational sequences, by performing the following:
replacing execution of old software parts with execution of new software parts; and
writing the old software parts into the first memory area;
wherein the new software parts are written into a second memory area and, due to a first branching in the first memory area, instead of the old software parts being executed in the first memory area, the new software parts are executed in the second memory area, the control unit, following the execution of the new software parts, branching back again into the first memory area via a second branching in the second memory area and the execution of the other software distinct from the old software parts being continued in the first memory area, the old software parts remaining in the first memory area.
